(19) United States
(12) Patent Application Publication
(10) Pub. No.: US 2003/0082347 A1
(43) Pub. Date: May 1, 2003

(54) Multilayer decorative tile

(76) Inventor: Kan Nakai, Haiku, HI (US)

Correspondence Address: NATH & ASSOCIATES PLLC, Sixth Floor, 1030 Fifteenth Street, N.W., Washington, DC, 20005, US

(21) Appl. No.: 09/984,864

(22) Filed: Oct. 31, 2001

(51) Int. Cl. B32B 23/02

(52) U.S. Cl. 428/192

(57) ABSTRACT

An ornamental laminate tile has a substrate layer, an outer transparent viewing layer, and an image layer. The substrate layer has an outer surface defined by outer surface edges and an inner surface defined by inner surface edges. The viewing layer has an outer surface defined by peripheral, outer surface edges and an inner surface defined by peripheral, inner surface edges, the outer surface of the viewing layer having a beveled peripheral edge portion, and the viewing layer edges extending beyond the substrate layer edges thereby defining a peripheral overhang between the viewing layer edges and the substrate layer edges. The image layer has an image thereon and is embedded between the viewing layer inner surface and the substrate layer inner surface. A filler or adhesive located only in the peripheral overhang forms a bonding seal between the viewing layer and the substrate layer, thereby resulting in an integral, one-piece tile that can butt against an adjacent tile without a gap between the two images.

### FIELD OF THE INVENTION

This invention relates to a decorative tile, and more particularly to a multilayer ornamental tile having an image. This type of tile can be used to cover walls or floors of a kitchen, bathroom, living room, or the like.

### BACKGROUND OF THE INVENTION

Decorative tiles have been used in the past to decorate and protect walls and floors. The multilayer structure and the ability to combine tiles to form a composite image or some decorative pattern, have also been known in the past.

The prior art, with its disadvantages and inadequacies, is exemplified in the following U.S. patents, the contents of each of which is incorporated herein in its entirety by reference.

The Barr U.S. Pat. No. 5,997,672 discloses a tile which attempts to protect photographic artwork (column 1, lines 15-23) and which comprises a glass tile encasing a photograph (column 1, lines 46-47). However, Barr's teaching requires a “slumped” flat glass margin which precludes abutment of the photographs of adjacent tiles so that an assembly of multiple such encased photos would display gaps. The tile has an adhesive layer against the back of the print, and requires a complex high-temperature manufacturing process.

The Bisker U.S. Pat. No. 5,863,632 discloses multi-layer decorative vinyl floor tiles, each comprising an embedded or encased photograph, which can be assembled into a composite image. However, a special 9 mm thick polyester photographic material is required which can be over-laminated with a clear vinyl layer in a pressure-intensive rolling process and which will support a backing material which is also applied in a pressure-intensive rolling process (column 3, lines 23-46). Furthermore, Bisker's tiles are neither rigid nor suitable for incorporation in conventional wall or floor tile arrays, and there is no suggestion as to how they might be adapted for this purpose.

The Itano U.S. Pat. No. 3,956,837 discloses a photograph mounted between a pair of free-standing clear frame elements. While showing a multilayer device for embedding and displaying a photograph, the Itano patent clearly does not provide a tile and clearly is not suitable for side-by-side assembly into a composite image.

The Klafert U.S. Pat. No. 6,150,075 discloses a transfer process of a photographic image to a slate tile surface and application of a polyacrylic coating. However, this process is not the same as embedding or encasing a paper or plastic photographic print, and is a complex wet process that has its own drawbacks.

The tiles of the aforedescribed prior art either require a sophisticated manufacturing process including costly and extreme procedures such as high pressure or high temperature, or do not allow the possibility of assembly with other similar or conventional tiles to provide a composite, gap-free image.

Thus, there is a need for a readily fabricated, multilayer photo display tile suitable for assembly with other such tiles displaying complementary photos to provide a composite image.

There is also a need for a means for solving the problem of encasing conventional photographs in tiles, for display, without applying adhesive to the back of the photograph.

### SUMMARY OF THE INVENTION

The present invention overcomes the deficiencies of the prior art by providing a multilayer ornamental tile that is easy to manufacture, that can make use of a simple photograph or image as decorative layer, and that is capable, either in-situ or off-site, of manufacture and/or of assembly with other similar or conventional tiles to provide a composite, gap-free image.

The present invention does not require any adhesive on the back or front of the photograph or image, or any sophisticated and costly procedure during manufacture.

The present invention permits the arrangement of multiple complementary tiles into a composite image while optically eliminating visual gaps between photographs, or photograph segments, in adjacent tiles.

The advantages of the present invention are realized in an ornamental laminate tile which in one embodiment is comprised of a top transparent layer having beveled edges, a substrate layer of slightly smaller surface than the top transparent layer so as to define an overhang between the top layer and the substrate layer, an image layer embedded between the top layer and the substrate layer, and an adhesive filler located in the overhang so as to bond the top layer to the substrate layer.

### BRIEF DESCRIPTION OF THE DRAWINGS

FIG.1 is a perspective view of a multilayer tile in accordance with the present invention.

FIG. 2 is an enlarged, cross-sectional view taken along line 2-2 in FIG. 1 and FIG. 2a is a further enlarged portion of FIG. 2.

FIG. 3 is a plan view of a composite image made by combining 25 multilayer tiles.

### DETAILED DESCRIPTION OF THE PREFERRED EMBODIMENT

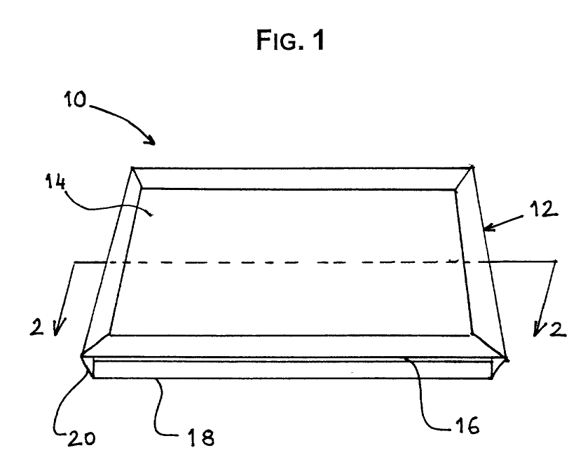

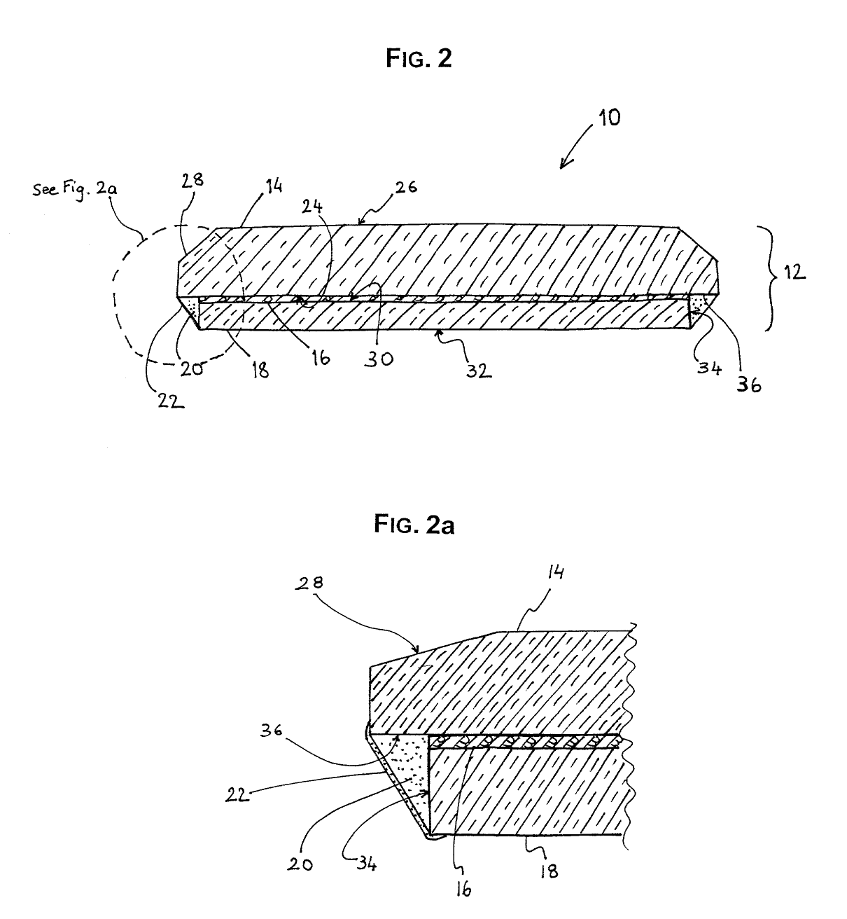

With reference now to the figures wherein like elements have the same number throughout the several views, and in particular with reference to FIG. 1 and FIG. 2, there is depicted a decorative multilayer tile 10 according to a preferred embodiment of the present invention. Tile 10 comprises a laminate body 12 which in turn is comprised of three laminates or layers, a top outermost layer 14, an image layer 16 (see FIG. 2) and a substrate layer 18.

Top outermost layer 14, sometimes also referred to as top piece 14 has a generally square, and thus rectangular, shape in plan view, with a planar or flat inner surface 24 and a planar or flat outer surface 26, each surface 24 and 26 being defined by peripheral edges. Outer surface 26 has a beveled edge portion 28.

Beveled edge portion 28 of top piece 14 introduces a slight optical magnification of image layer 16 as seen through top piece 14, thereby compensating for a difference of size between image layer 16 and top piece 14 and making image layer 16 appear as large as top piece 14. A typical width of beveled edge portion 28 is 6 mm, and an angle between beveled edge portion 28 and outer surface 26 is approximately 18 degrees.

Top piece 14 is transparent and is a protective viewing cover, preferably made of a conventional glass that has a hardness and resistance to penetration such that it can withstand normal forces, impacts and wear experienced by hard floor surfaces. Top layer 14 can also be made of a clear plastic, such as acrylic, with optical properties close to the optical properties of glass.

Substrate layer 18, sometimes also referred to as bottom piece 18, is a supporting layer, preferably also made of glass. Alternatively, substrate layer 18 can be made of a hard, yet easy to shape or mold, material such as ceramic. However, it can also be made of other materials such as wood, stone (e.g. granite or marble) or metal.

Bottom piece 18 has the same, generally square shape in plan view as top piece 14, but does not have a beveled edge portion and is smaller in size. Bottom piece 18 has two parallel planar or flat surfaces, inner surface 30 and outer surface 32, separated by a thin lateral edge surface 34 extending around bottom piece 18. A typical width of lateral surface 34 is approximately 4 mm. The dimensions of bottom piece inner surface 30 are smaller than the dimensions of top piece inner surface 24 so that, when tile 10 is assembled, the peripheral edge portions of top piece 14 extend beyond the corresponding edges of bottom piece 18, thereby defining a peripheral edge portion or overhang 36.

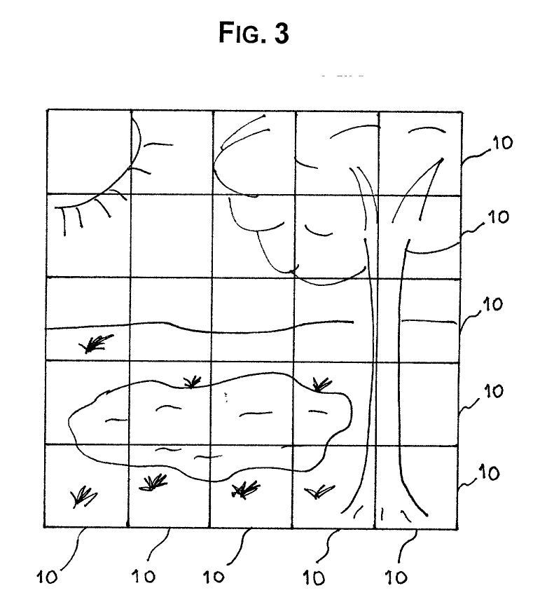

Image layer 16, is a thin, flexible layer, containing a decoration on one side such as a photograph or a picture. Image layer 16 is made of paper and a decorative image, as shown in FIG. 3, is printed or otherwise applied to one surface thereof.

Alternatively, image layer 16 can be a picture or painting on a plastic support, or on any other suitable media thin enough to be embedded between top layer 14 and substrate layer 18 without creating a gap at the peripheries thereof. Such media can include any type of films, of metal foil, plastic, textured paper, or even a wax paper type.

An adhesive filler 20, sometimes also referred to as cement 20, bonds top piece 14 to bottom piece 18 and has an exposed surface. Filler 20 fills the overhang 36 defined between the peripheral edges of top piece 14 and the edges of bottom piece 18, thereby bonding top piece 14 to bottom piece 18 along the peripheries thereof by adhering to bottom piece lateral surface 34 on one side, and to peripheral, exposed edge portion 36 of top piece inner surface 24, on the other side.

Filler 20 is preferably an epoxy resin, such as a commercial product known as White Marine-Tex™ and available from ITW Philadelphia Resins. Such a filler is a thermoset resin which has the properties of high strength, easy to apply, strong and permanent when cured, can be drilled and tapped, can be painted or sealed, has an adhesive shear strength that can exceed 1,800 psi and a tensile strength of about 4,000 psi, does not rust or corrode, and is resistant to attack from gasoline, oil and other hydrocarbon solvents, brine and many acids and alkalis. It can be mixed, applied, and cured at room temperatures of 72-78° F., is workable for about 25-35 minutes, and cures and hardens in 2-3 hours, with a full cure taking 18-24 hours.

A sealer 22 covers the exposed filler surface and a portion of the edges of top and bottom pieces 14 and 18, thereby keeping moisture out of laminate body 12 (see FIG. 2a). Sealer 22 is preferably an epoxy resin, such as a commercial product known as Gluvit™ and available from ITW Philadelphia Resins.

Such a sealer is an epoxy and is waterproof. It provides a hard protective coating that is flexible, impact resistant and abrasive resistant.

Exemplary dimensions of tile 10 are: 102 mm×102 mm×5 mm for top piece 14, and 98 mm×98 mm×4 mm for bottom piece 18.

Tile 10 can have other polygonal shapes, such as a hexagonal and triangular shape. It can also have any conceivable shape, such as round, oval or irregular if contiguous, abutting tiles are not required. Tile 10 can also have any other shape that will allow a beveled edge to be cut on the outer edge of top viewing layer 14.

Tile 10 can be easily manufactured and assembled, either at the site or in an off-site factory. It is assembled by providing an appropriately shaped top layer 14 and bottom layer 18, inserting an appropriately shaped image layer 16 between top and bottom layers 14 and 18, and then applying a previously mixed filler 20 around the periphery. The excess filler is removed, such as by a skimming blade and then allowed to dry at atmospheric conditions. If desired, curing time can be reduced by applying heat. After filler 20 is set, sealer 22 is applied on top of the outer surface of filler 20, with an overlap (as shown in FIG. 2a) onto top and bottom layers 14 and 18.

When multilayer tile 10 is assembled, image layer 16 is embedded between top piece 14 and bottom piece 18 and is coextensive with bottom piece inner surface 30. Image layer 16 is kept in place by simple contact between top piece 14 and bottom piece 18 with no adhesive being required on either side of image layer 16.

Other peripheral shapes of top piece 14 and bottom piece 18 are possible so as to provide a peripheral location or gap into which adhesive filler 20 can be placed. As just one example, both top and bottom pieces can have the same size and shape in plan view, but each has an inner peripheral cut away portion.

The ornamental tile described in the present invention can be used in a large variety of situations. The most common use is as surface-finishing, providing protection and decoration for large surfaces such as walls and floors.

Each tile can be used as an individual decorative item, when a whole picture is embedded within a single tile, or as an element of a composite image, when each tile contains a piece of the whole image.

In the case of a composite image, the present invention offers the advantage of allowing a gap-free image to be created. An example is depicted in FIG. 3, where 25 tiles in accordance with the present invention are combined to yield a large image. The combination of tiles wherein the image, as seen through the top transparent layer, reaches the edges of the tile, provides a composite image without any dead space between adjacent tiles.

Other possible uses of the present invention include, but are not limited to, surface finishing for pieces of furniture such as table tops, mirror frames, and any other suitable surface; free-standing photograph or image holder; and any other situation where a picture needs to be protected and seen with clarity.

Although only a few exemplary embodiments of the present invention have been described above, it will be appreciated by those skilled in the art that many changes may be made to these embodiments without departing from the principles and the spirit of the invention.

I claim:

1. An ornamental laminate tile comprising
a planar substrate layer having a peripheral edge;
a planar outer transparent viewing layer having a peripheral edge;
an image layer located between said outer viewing layer and said substrate layer; and
an adhesive filler located only between said peripheral edges of said substrate layer and said viewing layer, so as to rigidly adhere said substrate layer and said viewing layer.

2. An ornamental tile as claimed in claim 1 wherein
said tile has a square shape in plan view;
said substrate layer is made of glass;
said viewing layer is made of glass and has an outer surface and an inner surface, said outer surface having a beveled peripheral edge portion;
said image is coextensive with said substrate layer;
said filler is made of an epoxy resin; and
a sealer made of an epoxy resin covers said filler and a portion of said substrate layer edges.

3. An ornamental tile as claimed in claim 2, wherein said beveled edge portion is oriented with an angle such that said image layer, when viewed through said viewing layer, optically appears as large as said viewing layer.

4. An ornamental tile as claimed in claim 3, wherein no adhesive is applied to said image layer.

5. An ornamental tile as claimed in claim 4, wherein said image layer comprises a photograph.

6. An ornamental tile as claimed in claim 4, wherein said image layer comprises textured paper.

7. An ornamental laminate tile comprising
a substrate layer having an outer surface defined by outer surface edges and an inner surface defined by inner surface edges;
an outer transparent viewing layer having an outer surface defined by peripheral, outer surface edges and an inner surface defined by peripheral, inner surface edges, said outer surface of said outer viewing layer having a beveled peripheral edge portion, and said outer viewing layer edges extending beyond said substrate layer edges thereby defining a peripheral overhang between said outer viewing layer edges and said substrate layer edges;
an image layer embedded between said outer viewing layer inner surface and said substrate layer inner surface; and
an adhesive filler located in said overhang between said outer viewing layer edges and said substrate layer edges such that said outer viewing layer is rigidly attached to said substrate layer.

8. An ornamental tile as claimed in claim 7, wherein no adhesive is applied to said image layer.

9. An ornamental tile as claimed in claim 8, wherein said image layer has the same shape in plan view as said substrate layer.

10. An ornamental tile as claimed in claim 9, wherein said image layer is coextensive with said substrate layer.

11. An ornamental tile as claimed in claim 7, wherein said filler is applied only to said peripheral overhang.

12. An ornamental tile as claimed in claim 11, wherein said filler is an epoxy resin.

13. An ornamental tile as claimed in claim 11, wherein a sealer covers said filler.

14. An ornamental tile as claimed in claim 13, wherein said sealer also covers a portion of said substrate layer edges and is an epoxy resin.

15. An ornamental tile as claimed in claim 11, wherein said image layer comprises a photograph.

16. An ornamental tile as claimed in claim 11, wherein said image layer comprises textured paper.

17. An ornamental tile as claimed in claim 11, wherein said outer transparent viewing layer is made of glass.

18. An ornamental tile as claimed in claim 11, wherein said tile has a generally rectangular shape in plan view.

19. An ornamental tile as claimed in claim 18, wherein said tile has a square shape in plan view.

20. An ornamental tile as claimed in claim 7, wherein said beveled edge portion has a width larger than said overhang.

21. An ornamental tile as claimed in claim 20, wherein said beveled edge portion is oriented with an angle such that said image layer, when viewed through said viewing layer, optically appears as large as said viewing layer.

22. A method for manufacturing an ornamental laminate tile comprising the steps of:
providing a substrate layer having an outer surface defined by outer surface edges and an inner surface defined by inner surface edges; and an outer transparent viewing layer having an outer surface defined by peripheral, outer surface edges and an inner surface defined by peripheral, inner surface edges, said outer surface of said outer viewing layer having a beveled peripheral edge portion, and said outer viewing layer edges extending beyond said substrate layer edges thereby defining a peripheral overhang between said outer viewing layer edges and said substrate layer edges;
locating an image between said outer viewing layer inner surface and said substrate layer inner surface; and
applying an adhesive filler in said overhang between said outer viewing layer edges and said substrate layer edges and thereby bonding said outer viewing layer to said substrate layer.

23. A method for manufacturing an ornamental laminate tile as claimed in claim 22, wherein no adhesive is applied to said image layer.

24. A method for manufacturing an ornamental laminate tile as claimed in claim 23, and further comprising the step of applying a sealer to said adhesive filler wherein said filler is applied only to said peripheral overhang.

25. A method for manufacturing an ornamental laminate tile as claimed in claim 22, wherein said image is on a layer and said locating step comprises embedding an image layer between said outer viewing layer inner surface and said substrate layer inner surface.

26. A method for manufacturing an ornamental laminate tile as claimed in claim 22, wherein said applying step comprises filling the entire peripheral overhang with said adhesive filler.
